(19) United States
(12) Patent Application Publication
(10) Pub. No.: US 2017/0156164 A1
(43) Pub. Date: Jun. 1, 2017

(54) RADIO RESOURCE CONTROL OF USER STATE TRANSITIONS

(71) Applicant: VODAFONE IP LICENSING LIMITED, Newbury, Berkshire (GB)

(72) Inventors: Youssef CHAMI, London (GB); Iñigo GÜEMES, London (GB); Sumera KHALANDAR, London (GB)

(21) Appl. No.: 15/327,325

(22) PCT Filed: Jul. 9, 2015
(86) PCT No.: PCT/EP2015/065713

§ 371 Date: Jan. 18, 2017

(30) Foreign Application Priority Data
Jul. 18, 2014 (GB) 1412816.9

(51) Int. Cl. H04W 76/00; H04W 76/06; H04W 72/10; H04W 28/02; H04L 29/08; H04W 52/02; H04W 76/04; H04W 8/00

(52) U.S. Cl. CPC H04W 76/007; H04W 76/046; H04W 76/068; H04W 8/005; H04W 28/0268; H04L 67/303; H04W 52/0209; H04W 72/10

(57) ABSTRACT

The present disclosure provides radio resource controllers 110, RRCs, and methods for setting inactivity timers for user equipment devices, UEs. In one aspect, there is provided an RRC 110 for setting inactivity timers for UEs within a cell 140, the RRC being configured to: set a first inactivity timer for a first user equipment device, UE, 120 in the cell 140, wherein the first UE 120 is of a first user type; and set a second inactivity timer, separate to the first inactivity timer, for a second user equipment device, UE, 130 in the cell 140, wherein the second UE 130 is of a second user type. In a second aspect, there is provided an RRC 110 for dynamically setting a value of a first inactivity timer for a first UE 120 in a cell 140, wherein the first UE 120 is of a first user type, the RRC 110 being configured to: determine the value of the first inactivity timer based on at least the number of UEs in the cell 140 that are of the first user type and/or the number of UEs in the cell 140 that are of a second user type.

### TECHNICAL FIELD

The present disclosure relates to a radio resource controllers and associated methods for setting inactivity timers for first user equipment devices.

### BACKGROUND

The Third Generation Partnership Project (3GPP) has been developing enhancements to cellular systems to allow their operation for public safety or emergency services (ES) communications. These are especially intended to work with the Long Term Evolution (LTE) architecture. Aims of this approach may include: reduced cost; improved functionality; and increased flexibility in comparison with existing public safety communication infrastructure, such as the Terrestrial Trunked Radio (TETRA) network.

The objectives specified for critical voice and broadband services are that it should be affordable, to address pressures on user budgets; that it should be enhanced relative to the TETRA network, in order to provide integrated broadband services to meet user needs; and that it should be flexible, so as better to match and be responsive to user demand.

In order to achieve these objectives, the UK government has proposed a 4-lot procurement model:

1. Integration of services to migrate between legacy and new solutions

2. Services and User functionalities

3. Basic coverage using the commercial 4G (LTE) network

4. Coverage Extension

Commercial User Equipment (UE)—that is, typically, a handset such as a mobile telephone—is allocated randomly to one out of ten network access classes. The random allocation is performed by the SIM manufacturer or the service provider and is provisioned at the SIM/USIM prior to customer use. The allocation may be reconfigured for over-the-air (OTA) mobile populations, defined as Access Classes (AC) 0 to 9. The population number is stored in the SIM/USIM.

In addition, UEs may be members of one or more out of 5 special (high priority) categories (Access Classes 11 to 15), also held in the SIM/USIM. These are allocated to specific high priority users. The allocation is performed on-demand by customer services and the value provisioned OTA.
Class 15—PLMN Staff;
Class 14—Emergency Services;
Class 13—Public Utilities (e.g. water/gas suppliers);
Class 12—Security Services;
Class 11—For PLMN Use.

The skilled reader will recognise that none of the access class numbers are indicative of a hierarchy of importance, save that access classes 0-9 are reserved for commercial users whereas access classes 10-15 are reserved for higher priority users including the ES.

In LTE, there are a number of different defined user states, each of which may have differing levels of associated power consumption, for example ‘CONNECTED’/‘ACTIVE’ and ‘IDLE’. There is a limit on the number of users that can be supported in ‘CONNECTED’ Radio Resource Controller (RRC) mode at a given point in time. In a cellular network, an inactivity timer may be used to govern the number of customers supported within a cell area. The inactivity timer is used to monitor user activity. If a UE has not had any bearer data exchanged with the network for a considerable time (which is defined by the inactivity timer), the UE may be forced from Connected mode into Idle mode. When the inactivity timer expires, the network releases bearer resources, forcing the UE into Idle mode. The UE will no longer have an RRC connection with the Network after this. The UE has to re-establish an RRC connection if it needs to re-connect and second/receive data, at which point a new bearer channel is set up.

For example, after a period of inactivity equal to or exceeding the value of an inactivity timer, the status of a UE may be changed. For example, the UE may be moved from ‘CONNECTED’ RRC mode to ‘IDLE’ RRC mode. Moving the UE from one state to another after the inactivity timer has elapsed may help to optimise power (battery) consumption by moving the UE from a state of higher power consumption (for example, ‘CONNECTED’) to a state of lower power consumption (for example, ‘IDLE’) and also help to manage radio resources more effectively for limited Base Station resources.

The value of the inactivity timer may be pre-set or hard wired. For example, the inactivity timer value may be 20 seconds, wherein after 20 seconds of inactivity, the status of a UE is changed from ‘CONNECTED’ to ‘IDLE’.

Where both ES users and non-ES users (for example, commercial users) share the same cell, the number of ES users and non-ES users can vary. The inactivity timer may be set to a value that allows the maximum number of users within the cell. However, this results in incorrect usage of Network Usage and does not ensure that ES users are prioritised. Instead, it operates on a first come, first served basis.

It is desirable that in the event that the number of ES users within a cell increases to a large number (for example, in the event of an emergency), the support provided for ES users is optimised, whilst still minimising impact on non-ES users, thereby balancing the needs of ES users to get resources with a certain priority with the need to serve non-ES users (for example, commercial users) well.

### SUMMARY

The present disclosure provides a radio resource controller (RRC) for setting inactivity timers for user equipment devices, UEs, within a cell, the radio resource controller being configured to: set a first inactivity timer for a first user equipment device, UE, in a cell, wherein the first UE is of a first user type; and set a second inactivity timer, separate to the first inactivity timer, for a second user equipment device, UE, in a cell, wherein the second UE is of a second user type.

By setting separate first and second inactivity timers, the different needs and requirements of different user types may be serviced more adequately and more fairly. For example, the needs of first type UEs (such as Emergency Services UEs) to get resources with a certain priority may be balanced with the need to serve second type UEs (such as commercial UEs) within the cell fairly, thereby optimising the level of service provided to first type UEs whilst achieving fairness in service between first type UEs and second type UEs in the cell. Furthermore, power consumption for the UEs may be optimised, thereby improving UE battery life.

The first and second inactivity timers may be set to different values, for example the first inactivity timer may be set to a value greater than the value of the second inactivity timer. The second type UEs may thereby be given preferential access to the network over the first type UEs, whilst still serving commercial customers in a fair way. In some instances, however, the first and second inactivity timers may be set to the same value. Nevertheless, it will be appreciated that the first inactivity timer is still separate and distinct from the second inactivity timer, even when they are set to the same value.

Preferably, the RRC is further configured to dynamically determine a value of the first inactivity timer based on at least the number of UEs in the cell that are of the first user type and/or the number of UEs in the cell that are of the second user type.

Dynamically determining the value of the first inactivity timer enables the RRC to respond and adapt to changes in the number of UEs in the cell. In particular, it is possible to adapt the level of support provided to first type UEs in response to changes in the number of first type UEs and/or second type UEs within the cell, whilst minimising the impact on any other UEs within the cell. Thus, the needs of first type UEs to get resources with a certain priority may be balanced dynamically and more effectively with the need to serve other UEs within the cell fairly, thereby optimising the level of service provided to first type UEs whilst achieving fairness in service between first type UEs and any other UEs in the cell.

Preferably, the RRC is configured such that a decrease in the number of UEs in the cell that are of the first user type results in an increase in the determined value of the first inactivity timer, and that an increase in the number of UEs in the cell that are of the first user type results in a decrease in the determined value of the first inactivity timer. This inverse relationship between the number of first type UEs within the cell and the value of the first inactivity timer means that when the number of first type UEs is low and resource availability for other types of UEs is therefore high, the first type UEs can be given better service and performance by increasing their inactivity timer. However, when there are many first type UEs, the first inactivity timer can be given a shorter value so that the first type UEs can still have access to resources without limiting the resources available to other types of UE too severely.

Preferably, the RRC is configured to determine the value of the first inactivity timer further based on at least a value of the second inactivity timer. By considering the value of the second inactivity timer in addition to the number of first type UEs within the cell, the way in which second type UEs within the cell are treated will influence the determination of the first inactivity timer value, thereby improving fairness in the way in which first and second type UEs are treated within the cell.

The RRC may be configured such that the determined value of the first inactivity timer is greater than or equal to the value of the second inactivity timer. By ensuring that the first inactivity timer value is never less that the second inactivity timer value, the same minimum inactivity timer value, and therefore the same minimum level of service, may be afforded to both types of user.

The RRC may be configured to set the first inactivity timer separately from setting the second inactivity timer. For example, the first inactivity timer may be set by the RRC in a separate step to setting the second inactivity timer. Alternatively, they may both be set in the same step, although it will be appreciated that the first inactivity timer and the second inactivity timer will still be separate parameters. The setting of the first and second inactivity timers may be carried out as part of the same process (either separately or at the same time), or the setting of each may be carried out as part of separate processes.

Preferably, the RRC is configured to set the first inactivity timer and the second inactivity timer based on the requirements of the first user type users and/or the second user type users. For example, it may be set based on the users of the first user type requiring preferential access to the network and/or based on the users of the second user type requiring good, fair access to the network. In this way, the needs of one or both user groups may be considered in the setting of the first and second inactivity timers, so as to improve the quality of service and fairness of treatment for the first and/or second type users.

In a further aspect of the present disclosure, there is provided a radio resource controller (RRC) for dynamically setting a value of a first inactivity timer for a first user equipment device, UE, in a cell, wherein the first UE is of a first user type, the radio resource controller being configured to: determine the value of the first inactivity timer based on at least the number of UEs in the cell that are of the first user type and/or the number of UEs in the cell that are of a second user type.

This may optionally be performed independently from the setting of a second inactivity timer for second type UEs, in that the RRC may have no involvement in the setting of the second inactivity timer, or the RRC may set the second inactivity timer separately to setting the first inactivity timer.

Dynamically adjusting the value of the first inactivity timer enables the RRC to respond and adapt to changes in the number of UEs in the cell. In particular, it is possible to adapt the level of support provided to first type UEs in response to changes in the number of first type UEs and/or second type UEs within the cell, whilst minimising the impact on any other UEs within the cell. Thus, the needs of first type UEs to get resources with a certain priority may be balanced with the need to serve other UEs within the cell fairly, thereby optimising the level of service provided to first type UEs whilst achieving fairness in service between first type UEs and any other UEs in the cell. Furthermore, power consumption for the UEs may be optimised, thereby improving UE battery life.

Preferably, the RRC is configured such that a decrease in the number of UEs in the cell that are of the first user type results in an increase in the determined value of the first inactivity timer, and that an increase in the number of UEs in the cell that are of the first user type results in a decrease in the determined value of the first inactivity timer. This inverse relationship between the number of first type UEs within the cell and the value of the first inactivity timer means that when the number of first type UEs is low and resource availability for other types of UEs is therefore high, the first type UEs can be given better service and performance by increasing their inactivity timer. However, when there are many first type UEs, the first inactivity timer can be given a shorter value so that the first type UEs can still have access to resources without limiting the resources available to other types of UE too severely.

Preferably, the RRC is configured to determine the value of the first inactivity timer further based on at least a value of a second inactivity timer, wherein the second inactivity timer is for UEs in the cell that are of a second user type. By considering the value of the second inactivity timer in addition to the number of first type UEs within the cell, the way in which second type UEs within the cell are treated will influence the determination of the first inactivity timer value, thereby improving fairness in the way in which first and second type UEs are treated within the cell.

The RRC may be configured such that the determined value of the first inactivity timer is greater than or equal to the value of the second inactivity timer. By ensuring that the first inactivity timer value is never less that the second inactivity timer value, the same minimum inactivity timer value, and therefore the same minimum level of service, may be afforded to both types of user.

The first user type may comprise emergency services users and/or Public Safety services.

The second user type may comprise commercial users, or any users that are not of the first user type.

The RRC may be configured to apply the determined value of the first inactivity timer to the first user equipment. Thus, in addition to determining the value of the first inactivity timer, the RRC may also itself impose that first inactivity timer value on the first type UEs.

The user type of UEs within the cell may be determined based on at least one of a quality of service class identifier (QCI) of each UE in the cell, an access class (AC) of each the UE in the cell, a device type of each UE in the cell, a device range of each UE in the cell, a public land mobile network (PLMN) ID of each UE in the cell and/or a spectrum band of each UE in the cell.

The present disclosure also provides a base station (for example, an eNodeB, or any other type of network base station) comprising the radio resource controller disclosed above. Alternatively, the present disclosure provides a network server, or any network controller, comprising the radio resource controller disclosed above.

The present disclosure also provides a user equipment device (UE) comprising the radio resource controller disclosed above.

The present disclosure also provides a method for setting inactivity timers for user equipment devices (UEs) within a cell, the method comprising: setting a first inactivity timer for a first user equipment device, UE, in a cell, wherein the first UE is of a first user type; and setting a second inactivity timer, separate from the first inactivity timer, for a second user equipment device, UE, in a cell, wherein the second UE is of a second user type.

By setting separate first and second inactivity timers, the different needs and requirements of different user types may be serviced more adequately and more fairly. For example, the needs of first type UEs (such as Emergency Services UEs) to get resources with a certain priority may be balanced with the need to serve second type UEs (such as commercial UEs) within the cell fairly, thereby optimising the level of service provided to first type UEs whilst achieving fairness in service between first type UEs and second type UEs in the cell. Furthermore, power consumption for the UEs may be optimised, thereby improving UE battery life.

The first and second inactivity timers may be set to different values, for example the first inactivity timer may be set to a value greater than the value of the second inactivity timer. The second type UEs may thereby be given preferential access to the network over the first type UEs, whilst still serving commercial customers in a fair way. In some instances, however, the first and second inactivity timers may be set to the same value. Nevertheless, it will be appreciated that the first inactivity timer is still separate and distinct from the second inactivity timer, even when they are set to the same value.

The present disclosure also provides a method for dynamically setting a value of a first inactivity timer for a first user equipment device, UE, in a cell, wherein the first UE is of a first user type, the method comprising the step of: determining the value of the first inactivity timer based on at least the number of UEs in the cell that are of a first user type and/or the number of UEs in the cell that are of a second user type.

Dynamically adjusting the value of the first inactivity timer enables the RRC to respond and adapt to changes in the number of UEs in the cell. In particular, it is possible to adapt the level of support provided to first type UEs in response to changes in the number of first type UEs and/or the number of second type UEs within the cell, whilst minimising the impact on any other UEs within the cell. Thus, the needs of first type UEs to get resources with a certain priority may be balanced dynamically, or in real time, with the need to serve other UEs within the cell fairly, thereby optimising the level of service provided to the first type of UE whilst achieving fairness in service between first type UEs and any other UEs in the cell. Furthermore, power consumption for the UEs may be optimised, thereby improving UE battery life.

### BRIEF DESCRIPTION OF THE DRAWINGS

The invention may be put into practice in a number of ways, and some preferred embodiments will now be described by way of example only and with reference to the accompanying drawings, in which:

FIG. 1 shows a highly schematic diagram of a network structure for a cellular network including a radio resource controller and a plurality of user equipment devices (UE) of first and second network user types;

FIG. 2 depicts an example set of inactivity timer values for first type UEs and second type UEs in accordance with the prior art;

FIG. 3 shows an example set of inactivity timer values for first type UEs and second type UEs in accordance with the present disclosure;

FIG. 4 shows a graphical representation of the inactivity timer values for first type UEs and second type UEs of FIG. 3;

FIG. 5 shows an example control flow for setting inactivity timer values in accordance with the present disclosure.

### DETAILED DESCRIPTION

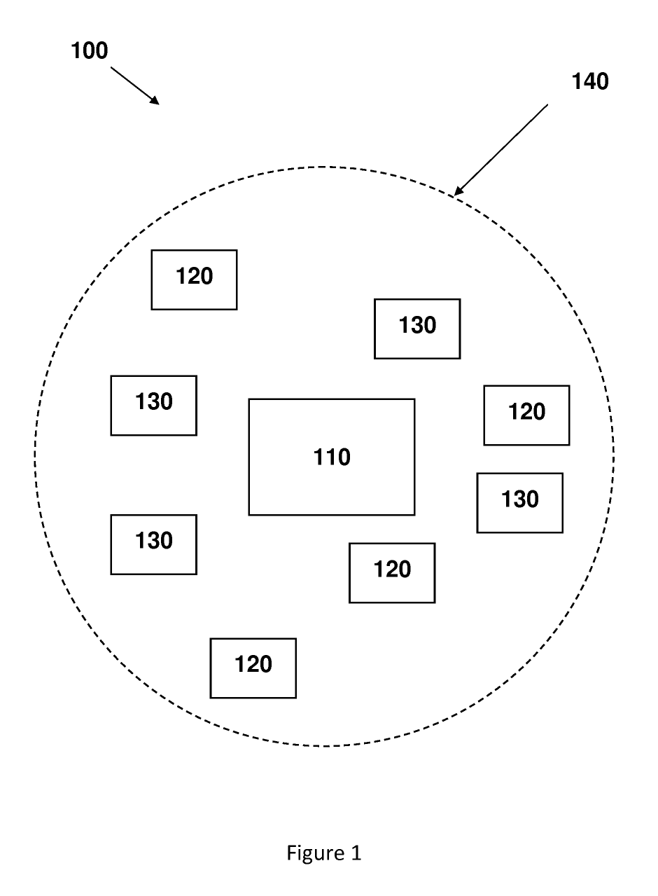

FIG. 1 shows a highly schematic diagram of a part of a telecommunications network (for example, an LTE network) 100.

The network 100 comprises a plurality of first type User Equipment nodes (UEs) labelled 120 that are within a cell 140 and are of a first user type. For example, the first user type may be for Emergency Services (ES), wherein the first type UEs 120 have an Access Class (AC) of 14. Each of the first type UEs 120 may be in communication with a base station (not depicted in FIG. 1).

Also shown in FIG. 1 is a plurality of second type UEs labelled 130 that are within the cell 140 and are of a second user type. For example, the second user type may be for commercial users, wherein the second type UEs 130 have an Access Class between 0 and 9, which is randomly allocated as explained in ‘background’ above. Each of these second type UEs 130 may be in communication with a base station (not depicted in FIG. 1).

It will of course be understood that there may be many more or fewer UEs (of both the first and second user types, or of any other user type) in a typical cell 140 at any given time and that no particular significance should be given to the number of UEs, or to the relative numbers of each type of UE, in FIG. 1. FIG. 1 is intended merely to illustrate the principles of the present disclosure.

Also shown in FIG. 1 is a radio resource controller (RRC) 110. The RRC may be implemented within a base station of the cell 140, for example in an eNodeB, or it may be implemented anywhere else in the wireless network, for example within a wireless network controller. One RRC may be provided for each cell within a wireless network, or multiple cells (i.e. two or more cells) may be serviced by a single RRC.

The time for which any UE within the cell 140 can be connected to the Network governs the total number of users supported within the cell 140 at any given time. This time therefore has to be shared between first type UEs 120 and second type UEs 130.

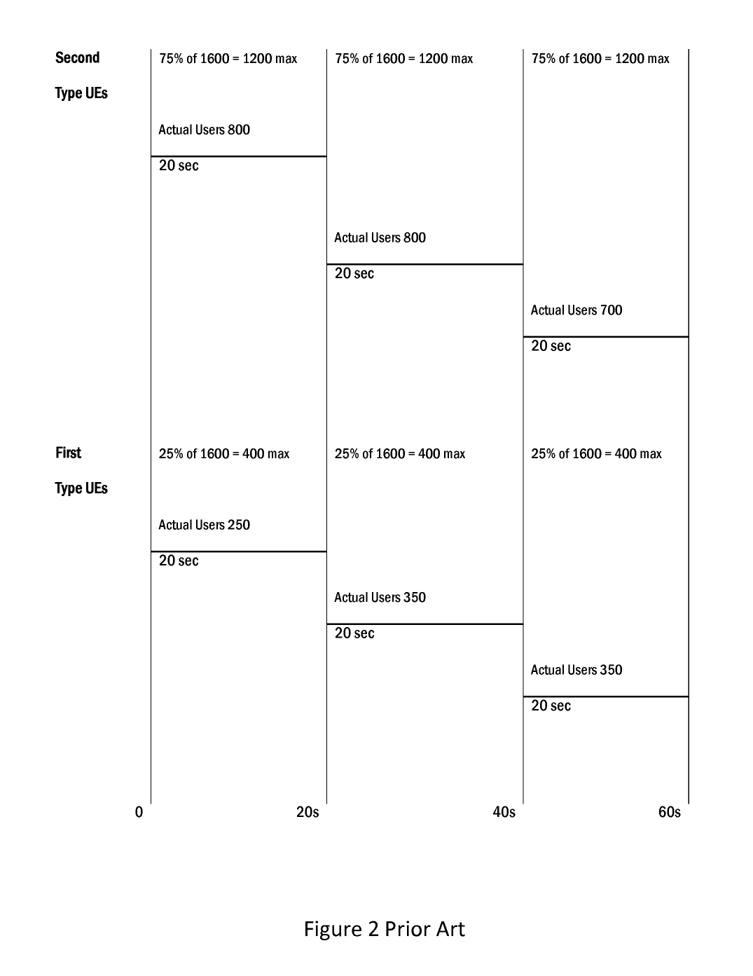

FIG. 2 shows a prior art technique for setting the inactivity timer value. In this example, the Network has an inactivity timer value of 20 seconds, which is applied to all UEs in the cell. This example assumes a projected cell usage of 75% second type UEs 130 and 25% first type UEs 120. The design maximum number of users supported in the cell 140 for LTE may be 2000, with an overload protection factor of 0.8, leaving a maximum of 1600 users supported in the cell 140, and thus a maximum of 1200 second type UEs 130 and 400 first type UEs 120. The resources of the cell 140 will be shared among both types of users as shown in FIG. 2 for the duration of the inactivity timer.

As can be seen in FIG. 2, the number of first type UEs 120 is increasing, but the system does not adapt to the change. By setting the inactivity timer values for all UEs in the cell to allow a maximum number of users in the cell, the configured maximum is disproportionate to the number of actual users in the cell 140. Resources that would be best utilised to support the growing number of first type UEs 120 are reserved for second type UEs 130 and are ultimately unutilised. Therefore, resources are not optimally used.

In contrast, in the present disclosure, the RRC 110 is configured to set a first inactivity timer for first type UEs 120 and a second inactivity timer for second type UEs 130, such that the different needs and requirements of different user types may be serviced.

In one example, the RRC 110 may be configured to set the first inactivity timer to an infinite period of time (or no inactivity timer set at all for first type UEs) such that first type UEs 120 always remain in the “CONNECTED” state and have constant access to the network. The RRC 110 may be further configured to set the second inactivity timer to a finite value, for example 20 or 30 seconds. However, whilst in some senses it may be preferable for first type users to have constant access to the network, such a scheme may be disruptive to second type UEs 130 who need to be served on the network and may result in an unfair and inefficient distribution of network resources.

In a further example, the RRC 110 is configured to set the first inactivity timer to a first value (for example, 40, or 50, or 60 seconds etc) and the second inactivity timer to a different value (for example 20, or 25, or 30 seconds). If the first inactivity timer is set to a different value to the second inactivity timer, the first type users can be given a different level of network service to the second type users. For example, if the first inactivity timer is set to a value greater than the second inactivity timer, the first type UEs 120 may be given preferential access to the network, whilst still serving the second type UEs 130 in a fair way by virtue of the value set for the second inactivity timer. Thus, a better balance between the needs of the first type users to have resources with a certain priority and the needs of second type users to be served in a fair way may be achieved.

In these examples, the RRC 110 may be configured to set the first and second inactivity timers in separate steps (for example, setting the first inactivity timer and then setting the second inactivity timer, or vice-versa), or it may be configured to set the first and second inactivity timers at the same time, in the same step. Furthermore, if set in separate steps, each setting step may be a part of the same RRC 110 control process, or separate processes performed by the RRC (for example, one process for setting the first inactivity timer and a separate process for setting the second inactivity timer).

In a further aspect, the RRC is configured to dynamically increase or decrease the number of UEs within the cell 140 using the inactivity timer for different types of UE. In particular, the RCC 110 is configured to dynamically adjust the inactivity timer value for the first type UEs 120 whilst keeping the inactivity timer value for the second type UEs 130 fixed. The maximum number of users supported in a cell is finite, and by dynamically adjusting the inactivity timer for first type UEs 120, it is possible to achieve a model that dynamically optimises the number of first type UEs 120 supported for a given % of user types.

The relationship between the value of the first inactivity timer for first type UEs 120 and the value of the second inactivity timer for second type UEs 130 may be made dependent on the number of users supported in the cell 140. For a given number of Emergency users to be supported, a dependency can be devised on their inactivity timer. An example relationship between the value of the first inactivity timer and the number of each user type within the cell 140 is represented in the equation below:

Te=To+(1/((Ep*To)/(MAX(1, Ou))*LOG 10(1/MAX(1, Ou))̂2)*k

Te is the value of the first inactivity timer for first type UEs 120.

To is the value of the second inactivity timer for second type UEs 130.

Ep is the total number of first type UEs 120 that are in the cell 140.

Ou is the total number of second type UEs 130 that are in the cell 140.

k is a constant, which may be set to any suitable value, for example during set-up of the RRC. The value of k may be, for example, 10, 100, 300 etc.

As can be seen, the relationship between the value of the first inactivity timer and the number of each user type within the cell 140 is such that for a lower number of first type UEs 120, Te is set to a larger value. For a greater number of first type UEs 120 within the cell 140, Te is set to a shorter value. Thus, it can be said that there is an inverse relationship between the number of first type UEs 120 within the cell 140 and the value of the first inactivity timer.

This may be beneficial because when the number of first type UEs 120 is low, there is a lot of resource available for second type UEs 130. Thus, it is possible to allow the first type UEs 120 to have a better service and therefore have a better performance by giving them more connection time. However, when there is a larger number of first type UEs 120, it may be beneficial to allow the first type UEs 120 to have access to resources without limiting the resources available to second type UEs 130 too severely. If the connection time available to first type UEs 120 is too long, the second type UEs 130 may be unfairly penalised over first type UEs 120, so a shorter first inactivity timer value is preferable. Therefore, this relationship between the value of the first inactivity timer and the number of each user type within the cell 140 can achieve a desirable balance between the needs of first type UEs 120 to get Network resources with a certain priority and the need to serve the second type UEs 130 well, thereby achieving fairness in service between first and second type UEs.

As can be seen in the above example formula, the RRC 110 can be configured to determine the value of the first inactivity timer Te to be greater than or equal to the value of the second inactivity timer To, such that the same minimum inactivity timer value is available for both types of UE and the same minimum level of service therefore afforded to both types of user.

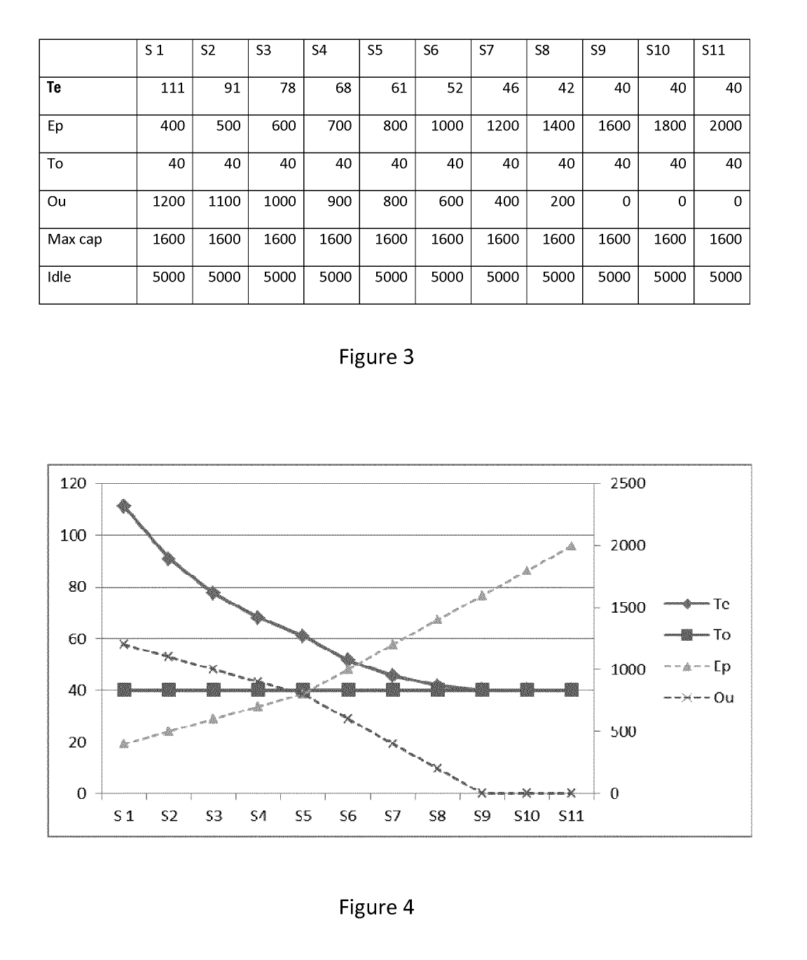

FIG. 3 shows a table demonstrating how the first timer value Te may dynamically change with changes in the number of first type UEs 120, Ep, within the cell 140 and the number of second type UEs 130, Ou, within the cell 140, in accordance with the above example formula.

The table shown in FIG. 3 assumes a maximum cap of 2000 users within the cell 140 and an overhead of 0.8, thereby allowing a maximum number of 1600 users in the cell 140. The table further assumes a maximum number of first type UEs 120 (Ep) within the cell of 40% of the total maximum (i.e. 40% of 1600, which is 640) and a maximum number of second type UEs 130 (Ou) within the cell of 60% of the total maximum (i.e. 60% of 1600, which is 960). The second inactivity timer, To, which is used for the second type UEs 130 is set to 40 seconds and the constant k is set to 100. It will be appreciated that these figures are used by way of example only and that they may be set to any other suitable value. Furthermore, it will also be appreciated that the maximum number of first and second type UEs do not together have to total 100% of the maximum capacity, but may together total less than 100% of the maximum cell capacity, for example to allow for any other types of UE to be served by the cell.

As shown in FIG. 3, as the number of first type users increases and the number of second type users decreases, the first inactivity timer Te becomes shorter, until it reaches 40 seconds, which is the value of the second inactivity timer, To.

FIG. 4 shows a graphical representation of the data presented in FIG. 3, which shows changes in the value of the first inactivity timer, Te, resulting from changes in the numbers of first and second type UEs in the cell 140.

Thus, it is evident that the first inactivity timer value is extended as the number of first user type UEs supported in the cell 140 reduces and vice versa. Therefore, the system is able to improvise the first inactivity timer value used for first type UEs 120 if the observed number of users is less than planned. Direct control of which users may be allowed to latch on to the system and for how long may thereby be imposed. Networks may be set up with a cookie cutter configuration across cell sites and as a situation develops, each cell site can adapt to changes in the number of users of either or both types.

The RRC 110 may obtain the data it requires regarding the number of first type UEs 120 in the cell 140 and the number of second type UEs 130 in the cell 140 by any suitable means. For example, the Network may feedback traffic data to the RRC 110, or the RRC 110 may obtain the necessary data for itself, for example by monitoring activity in the cell 140. Thus, available network metrics regarding developing conditions can be utilised so that the system can adapt suitably.

The RRC 110 may dynamically determine a value for the first inactivity timer Te at any time such that any changes in the numbers of first and/or second user type UEs in the cell 140 may affect the first inactivity timer value Te. However, it may be arranged that any changes to timer values are effected only when the current timer runs out in order to avoid “in-cycle” changes. In this way, it is possible to prevent changes to a timer while a timer is running. Once a timer has run out to its completion, a new setting can then take effect. For example, if To=40 seconds and Te=110 seconds, it may be preferred that any change to Te only take place after at least 40 seconds (i.e. after To, or one cycle). It may be advisable to limit the number of changes to Te to a reasonable level. It is possible to keep another independent timer to govern this, for example set to an arbitrary time for which Te is left unchanged or to multiples of To, such as To, or 2×To or 3×To etc. The aim may be not to let changes happen randomly or too frequently.

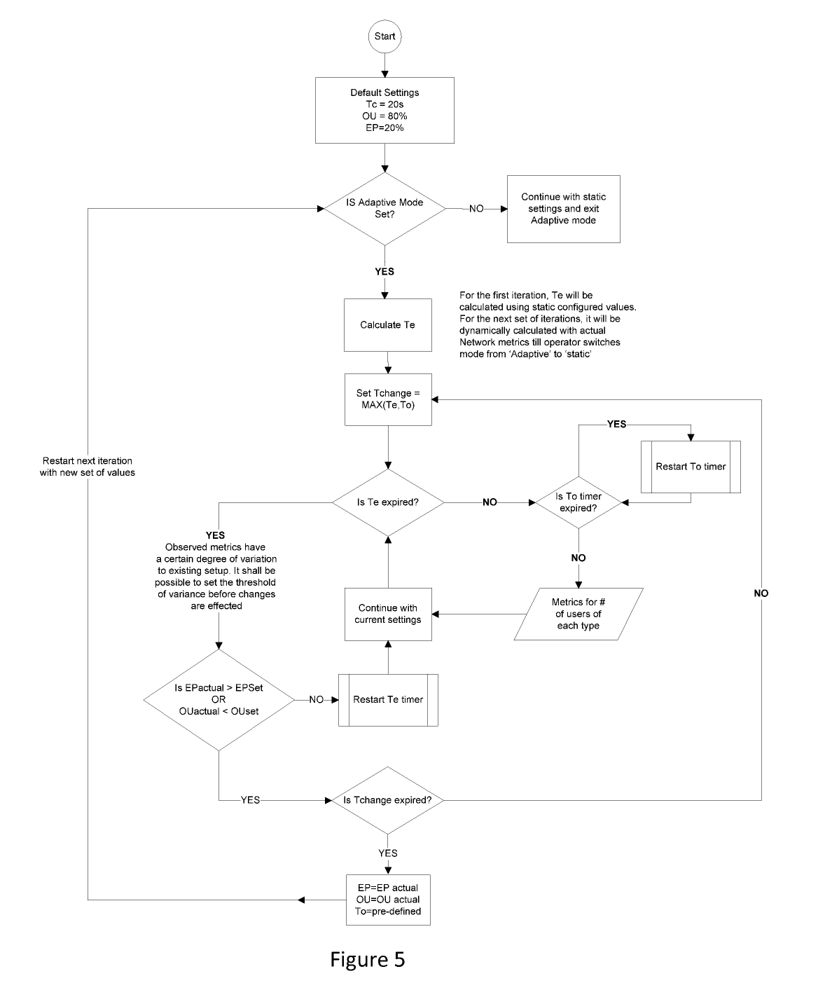

FIG. 5 shows an example representation of an application control flow for dynamic/adaptive RRC 110 transition of the value for the first inactivity timer Te. If the above described process of setting the value of the first inactivity timer (Te) were implemented as software logic to be executed on the processor of an electronic device (for example, in the RRC 110 on a network server or UE), FIG. 5 shows an example of how that software logic may execute the process.

FIG. 5 indicates default settings of To=20 seconds, Ou=80% and Ep=20%. These default settings are that the value of the second inactivity timer (To) is 20 seconds, the number of first type UEs 120 in the cell 140 is 20% of the maximum number of UEs allowed in the cell and the number of second type UEs 130 allowed in the cell 140 is 80% of the maximum number of UEs allowed in the cell. These percentages are by way of example only and it will be appreciated that the default settings may be set to any suitable value. For example, To may be 5, 10, 15, 25, 40, 60 seconds etc and/or Ou may be 10, 20, 40, 50, 70, 90, 95% etc and/or Ep may be 90, 80, 60, 50, 30, 10, 5% etc. Furthermore, it will be appreciated that the default percentages for Ou and Ep do not together have to total 100%, but may together total less than 100%, for example to allow for other types of user to be served by the cell.

The maximum cap within cell 140 may, for example, be 2000 and an overhead of 0.8 may, for example, be imposed. Therefore, the maximum number of UEs allowed in the cell may, for example, be 1600.

Although specific aspects have been described, it will be recognised that a number of variations or modifications may be employed. For example, although Emergency Service or Public Safety communication service has been considered herein, the techniques described may be applied to other types of system. In general, the system can distinguish between two different types of users (first user type UEs and second user type UEs) within a cell and set the inactivity timers accordingly.

Therefore, whilst the above generally describes the first type UEs 120 as Emergency Services UEs, it will be appreciated that the first user type may be any user category or categories. Furthermore, whilst the above generally describes the second type UEs 130 as commercial UEs, it will be appreciated that the second user type may be any user category, or may be any UE within the cell 140 that does not belong to the first user type.

In the above, first type UEs 120 are distinguished from second type UEs 130 by considering the Access Class (AC) of each UE. However, first and second type UEs may be distinguished from each other using any other suitable means. For example, the system may consider at least one of the quality of service class identifier (QCI), the access class (AC), device type, device range, public land mobile network (PLMN) ID, Spectrum Band etc.

The above disclosure describes an RRC 110 that dynamically sets a value of the first inactivity timer for first type UEs 120 in a single cell 140. However, the system may be extended across two or more cells, which may or may not be geographically close, such that the number and type of users in the two or more cells may be considered when determining the value of the first inactivity timer for one or more of the cells. Furthermore, the RRC 110 might determine the first inactivity timer value for two or more cells, but consider each of the cells 140 independently, such that the number of UEs in one cell is considered in order to determine a first inactivity timer value for that cell, and the number of UEs in a second cell is considered in order to determine a first inactivity timer value for that cell.

Whilst a particular way of dynamically determining the value of the first inactivity timer Te is disclosed above (as represented by the formula for Te), it will be appreciated that any suitable technique may alternatively be used. In particular, whilst the example formula considers the value of the second inactivity timer, the number of first type UEs 120 in the cell 140 and the number of second type UEs 130 in the cell 140, it will be appreciated that only one, or any combination of two or more, of these factors may be utilised to determine the value of the first inactivity timer. Furthermore, the relationship between the value of the first inactivity timer and the value of the second inactivity timer, the number of first type UEs 120 in the cell 140 and/or the number of second type UEs 130 in the cell 140 may take any suitable form.

Furthermore, whilst the above disclosure describes dynamically determining the value of the first inactivity timer particularly in the context of setting the first inactivity timer and setting the second inactivity timer (which would usually be a fixed value), it will be appreciated that dynamically determining the value of the first inactivity timer may take place independently from setting the second inactivity timer. For example, there may be no second type UEs 130 in the cell, or the RRC 110 may be configured to determine the value of the first inactivity timer (perhaps, optionally, in consideration only of the number of first type UEs 120 in the cell 140) and not to have any involvement in setting the second inactivity timer for second type UEs 130.

Furthermore, whilst the above RRC 110 is usually described as setting the first inactivity timer to a value that is different to the second inactivity timer, it will be appreciated that in some instances the first inactivity timer may be set to a value that is the same as the value of the second inactivity timer. Nevertheless, the first inactivity timer and second inactivity timer are still separate parameters, the former applying to first type UEs 120 and the latter applying to second type UEs 130.

Furthermore, whilst particular examples for the value of the second inactivity timer, To, and the maximum numbers of first and second type UEs in the cell 140 are disclosed above, it will be appreciated that these may be set to any suitable value. Furthermore, whilst the value of the second inactivity timer, To, is usually described as fixed, it will be appreciated that it may be changed or altered at any time.

The RRC 110 disclosed herein may be implemented within any suitable Network device. For example, it may be implemented within an eNodeB, or any other suitable Network Server/Network Controller, or within a UE in the cell 140, or any other cell. Furthermore, the functionality of the RRC 110 may be split across two or more devices that are directly or indirectly interconnected in order to carry out the functionality disclosed herein.

FIG. 5 shows a particular example process by which the value of the first inactivity timer may be determined and then set. However, it will be appreciated that any suitable process may be used to determine and set the first inactivity timer value. Furthermore, whilst the RRC may both determine the value of the first inactivity timer and apply the determined first inactivity timer value to one, many or all of the first type UEs 120, in an alternative arrangement the RRC 110 may only determine the value of the first inactivity timer. A different network element, which may be directly or indirectly interconnected with the RRC 110, may then apply the determined first inactivity timer value to the first type UEs 120. For example, the RRC 110 may pass the determined first inactivity timer value to a different Network Element, such as an eNodeB, for applying to the first type UEs 120.

1. A radio resource controller for setting inactivity timers for user equipment devices, UEs, within a cell, the radio resource controller being configured to:
set a first inactivity timer for a first user equipment device, UE, in the cell, wherein the first UE is of a first user type; and
set a second inactivity timer, separate to the first inactivity timer, for a second user equipment device, UE, in the cell, wherein the second UE is of a second user type.

2. The radio resource controller of claim 1, further configured to dynamically determine a value of the first inactivity timer based on at least the number of UEs in the cell that are of the first user type and/or the number of UEs in the cell that are of the second user type.

3. The radio resource controller of claim 2, configured such that a decrease in the number of UEs in the cell that are of the first user type results in an increase in the determined value of the first inactivity timer, and that an increase in the number of UEs in the cell that are of the first user type results in a decrease in the determined value of the first inactivity timer.

4. The radio resource controller of either claim 2 or claim 3, configured to determine the value of the first inactivity timer further based on at least a value of the second inactivity timer.

5. The radio resource controller of claim 4, configured such that the determined value of the first inactivity timer is greater than or equal to the value of the second inactivity timer.

6. The radio resource controller of any preceding claim, configured to set the first inactivity timer separately from setting the second inactivity timer.

7. The radio resource controller of any preceding claim, configured to set the first inactivity timer and the second inactivity timer based on the requirements of the first user type users and/or the second user type users.

8. A radio resource controller for dynamically setting a value of a first inactivity timer for a first user equipment device, UE, in a cell, wherein the first UE is of a first user type, the radio resource controller being configured to:
determine the value of the first inactivity timer based on at least the number of UEs in the cell that are of the first user type and/or the number of UEs in the cell that are of a second user type.

9. The radio resource controller of claim 8, configured such that a decrease in the number of UEs in the cell that are of the first user type results in an increase in the determined value of the first inactivity timer, and that an increase in the number of UEs in the cell that are of the first user type results in a decrease in the determined value of the first inactivity timer.

10. The radio resource controller of either claim 8 or claim 9, configured to determine the value of the first inactivity timer further based on at least a value of a second inactivity timer, wherein the second inactivity timer is for UEs in the cell that are of the second user type.

11. The radio resource controller of claim 10, configured such that the determined value of the first inactivity timer is greater than or equal to the value of the second inactivity timer.

12. The radio resource controller of any of claims 8 to 11, configured to:
apply the determined value of the first inactivity timer to the first UE.

13. The radio resource controller of any preceding claim, wherein the first user type comprises emergency services users.

14. The radio resource controller of any preceding claim, wherein the second user type comprises commercial users.

15. The radio resource controller of any preceding claim, wherein the user type of UEs within the cell is determined based on at least one of a quality of service class identifier of the UE, an access class of the UE, a device type of the UE, a device range of the UE, a public land mobile network ID of the UE and/or a spectrum band of the UE.

16. A base station comprising the radio resource controller of any preceding claim.

17. A user equipment device comprising the radio resource controller of any preceding claim.

18. A method for setting inactivity timers for user equipment devices (UEs) within a cell, the method comprising:
setting a first inactivity timer for a first user equipment device, UE, in a cell, wherein the first UE is of a first user type; and
setting a second inactivity timer, separate from the first inactivity timer, for a second user equipment device, UE, in a cell, wherein the second UE is of a second user type.

19. A method for dynamically setting a value of a first inactivity timer for a first user equipment device, UE, in a cell, wherein the first UE is of a first user type, the method comprising the step of:
determining the value of the first inactivity timer based on at least the number of UEs in the cell that are of a first user type and/or the number of UEs in the cell that are of a second user type.
